(19) United States
(12) Patent Application Publication
(10) Pub. No.: US 2025/0024498 A1
(43) Pub. Date: Jan. 16, 2025

(54) SENSING SIGNAL SENDING METHOD AND APPARATUS, DEVICE AND STORAGE MEDIUM

(71) Applicant: BEIJING XIAOMI MOBILE SOFTWARE CO., LTD., Beijing (CN)

(72) Inventor: Dong CHEN, Beijing (CN)

(73) Assignee: BEIJING XIAOMI MOBILE SOFTWARE CO., LTD., Beijing (CN)

(21) Appl. No.: 18/705,488

(22) PCT Filed: Oct. 26, 2021
(86) PCT No.: PCT/CN2021/126282

§ 371 Date: Apr. 26, 2024

(51) Int. Cl. H04W 74/0816; H04W 72/04; H04W 74/08

(52) U.S. Cl. CPC H04W 74/0816; H04W 72/04; H04W 74/0866

(57) ABSTRACT

A method for sending a sensing signal includes: determining a characteristic of a sensing service; determining, based on the characteristic of the sensing service, an unoccupied first sensing resource in sensing resources to be allocated; and sending the sensing signal based on the first sensing resource.

### CROSS REFERENCE TO RELATED APPLICATION

This application is a National Stage of International Application No. PCT/CN2021/126282, filed on Oct. 26, 2021, which is incorporated by reference herein in its entireties for all purposes.

### BACKGROUND

The sensing system, also known as Radar (radio detection and ranging), uses radio to find targets and determine their spatial positions. As also called “radio location”, Radar emits electromagnetic wave to irradiate the target and receives echo, thereby obtaining information including the distance from the target to the electromagnetic wave emission point, the distance change rate (radial velocity), azimuth, height and the like.

### SUMMARY

This disclosure relates to the technical field of wireless communication, and in particular, to a method, an apparatus, a device and a storage medium for sending sensing signal. This disclosure provides a method, an apparatus, a device and a storage medium for sending sensing signal.

According to a first aspect of some embodiments of this disclosure, there is provided a method for sending a sensing signal, which is to be executed by user equipment (UE) and includes: determining a characteristic of a sensing service; determining, based on the characteristic of the sensing service, an unoccupied first sensing resource in sensing resources to be allocated; and sending the sensing signal based on the first sensing resource.

According to a second aspect of some embodiments of this disclosure, a mobile terminal is provided and includes: a processor; and a memory, configured to store an instruction executable by the processor; where the processor is configured to execute the executable instruction in the memory, thereby implementing steps of the forgoing method for sending the sensing signal.

According to a third aspect of some embodiments of this disclosure, there is provided a non-transitory computer-readable storage medium storing an executable instruction thereon, where the executable instruction is used for, when being executed by a processor, implementing steps of the forgoing method for sending the sensing signal.

Both the foregoing general description and the following detailed description are exemplary and explanatory only and are not restrictive of this disclosure.

### BRIEF DESCRIPTION OF THE DRAWINGS

The drawings described here are used to provide a further understanding of some embodiments of this disclosure, and constitute a part of the application. The schematic embodiments of this disclosure and their descriptions are used to explain some embodiments of this disclosure, and do not constitute undue limitation to the embodiments of this disclosure. In the drawings:

FIG. 1 is a flow chart showing a method for sending a sensing signal according to some embodiments of the present disclosure;

FIG. 2 is a flow chart showing a method for sending a sensing signal according to some embodiments of the present disclosure;

FIG. 3 is a flow chart showing a method for sending a sensing signal according to some embodiments of the present disclosure;

FIG. 4 is a flow chart showing a method for sending a sensing signal according to some embodiments of the present disclosure;

FIG. 5 is a block diagram of an apparatus for sending a sensing signal according to some embodiments of the present disclosure; and

FIG. 6 is a structural diagram of a device for sending a sensing signal according to some embodiments of the present disclosure.

### DETAILED DESCRIPTION

Embodiments of this disclosure will now be further described in conjunction with the accompanying drawings and detailed examples.

Reference will now be made in detail to the exemplary embodiments, examples of which are illustrated in the accompanying drawings. When the following description refers to the accompanying drawings, the same numerals in different drawings refer to the same or similar elements unless otherwise indicated. The implementations described in the following exemplary embodiments do not represent all implementations consistent with the embodiments of this disclosure. Rather, they are merely examples of apparatuses and methods consistent with aspects of this disclosure as recited in the appended claims.

Some embodiments of this disclosure may include a plurality of steps; these steps are numbered for ease of description. However, these numbers are not intended to limit the execution time slots and execution order between the steps. These steps may be implemented in any proper order, which is not limited by the embodiments of this disclosure.

In the sensing system, objects are discovered and their spatial positions are determined by means of radio. However, when sensing signals are sent in unlicensed frequency bands, interference may occur due to the lack of mutual coordination among sensing devices.

In some embodiments, the sensing resources to be allocated in this application may be divided in advance into the following time periods: T₀, T₁, T₂, . . . , T_{N-1}, T₀, T₁, T₂, . . . , T_{N-1}, T₀, T₁, T₂, . . . , T_{N-1}, . . . ; where N is a positive integer greater than or equal to 1.

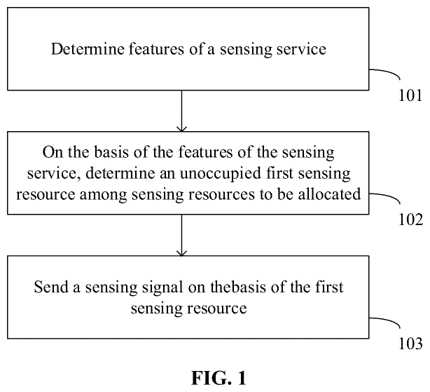

Some embodiments of this disclosure provide a method for sending a sensing signal, which is executed by user equipment (UE). The method may be executed independently, or may be executed in combination with any of other embodiments of this disclosure. FIG. 1 is a flow chart of a method for sending a sensing signal according to some embodiments. As shown in FIG. 1, the method includes the following content.

In step 101, a characteristic of the sensing service is determined.

In step 102, an unoccupied first sensing resource is determined in sensing resources to be allocated based on the characteristic of the sensing service.

In step 103, the sensing signal is sent based on the first sensing resource.

In some embodiments, the UE determines the characteristic of the sensing service, determines the unoccupied first sensing resource among the sensing resources to be allocated based on the characteristic of the sensing service, and sends the sensing signal based on the first sensing resource.

In the forgoing embodiments, before sending the sensing signal, the UE monitors whether the sensing resource to be used for sending sensing signal is occupied by other devices, and only sends the sensing signal when the sensing resource is not occupied, so that the sensing signal can be successfully sent.

Some embodiments of this disclosure provide a method for sending a sensing signal, which is executed by UE. The method may be executed independently, or may be executed in combination with any of other embodiments of this disclosure. The method includes:
determining a characteristic of a sensing service;
determining, based on the characteristic of the sensing service, an unoccupied first sensing resource in sensing resources to be allocated; and
sending the sensing signal based on the first sensing resource,
where the sensing resources to be allocated are resources on an unlicensed frequency band.

In some embodiments, when the UE is to send the sensing signal by using the resources on the unlicensed frequency band, the UE determines the characteristic of the sensing service, determines the unoccupied first sensing resource among the sensing resources to be allocated based on the characteristic of the sensing service, and sends the sensing signal based on the first sensing resource.

In the forgoing embodiments, when the UE is to send the sensing signal by using the resources on the unlicensed frequency band, the UE monitors, before sending the sensing signal, whether the sensing resource to be used for sending sensing signal is occupied by other devices, and only sends the sensing signal when the sensing resource is not occupied, so that the sensing signal can be successfully sent.

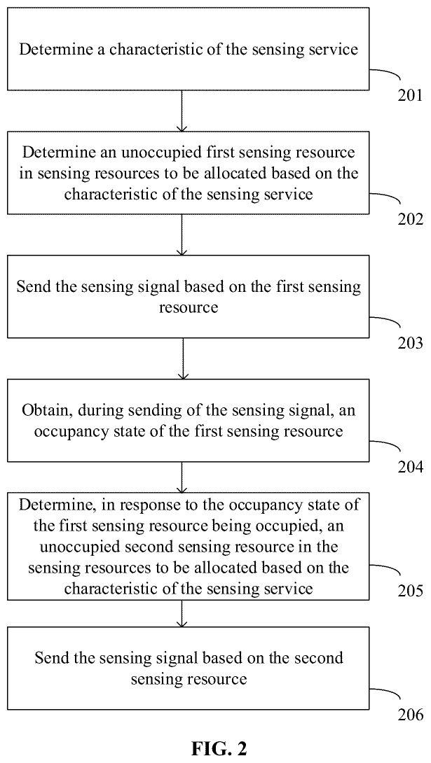

Some embodiments of this disclosure provide a method for sending a sensing signal, which is executed by UE. The method may be executed independently, or may be executed in combination with any of other embodiments of this disclosure. FIG. 2 is a flow chart of a method for sending a sensing signal according to some embodiments. As shown in FIG. 2, the method includes the following content.

In step 201, a characteristic of the sensing service is determined.

In step 202, an unoccupied first sensing resource is determined in sensing resources to be allocated based on the characteristic of the sensing service.

In step 203, the sensing signal is sent based on the first sensing resource.

In step 204, during sending of the sensing signal, an occupancy state of the first sensing resource is obtained.

In step 205, in response to the occupancy state of the first sensing resource being occupied, an unoccupied second sensing resource is determined in the sensing resources to be allocated based on the characteristic of the sensing service.

In step 206, the sensing signal is sent based on the second sensing resource.

In some embodiments, the UE determines the characteristic of the sensing service, determines the unoccupied first sensing resource among the sensing resources to be allocated based on the characteristic of the sensing service, and sends the sensing signal based on the first sensing resource. In the process of sending the sensing signal, the UE obtains the occupancy state of the first sensing resource, determines, if the occupancy state of the first sensing resource is occupied, the unoccupied second sensing resource among the sensing resources to be allocated based on the characteristic of the sensing service, and resends the sensing signal based on the second sensing resource.

In some embodiments, the UE determines the characteristic of the sensing service, determines, based on the characteristic of the sensing service, a first candidate sensing resource among the sensing resources to be allocated, and obtains the occupancy state of the first candidate sensing resource. When the occupancy state of the first sensing resource is unoccupied, the UE determines the first candidate sensing resource as the first sensing resource; when the occupancy state of the first candidate sensing resource is occupied, the UE repeats the following operations until the occupancy state of an updated first candidate sensing resource is unoccupied: determining an updated first candidate sensing resource based on the characteristic of the sensing service, obtaining an occupancy state of the updated first candidate sensing resource, determining the updated first candidate sensing resource as the first sensing resource, and sending the sensing signal based on the first sensing resource.

In the process of sending the sensing signal, the occupancy state of the first sensing resource is obtained, and if the occupancy state of the first sensing resource is occupied, a second candidate sensing resource is determined among the sensing resources to be allocated based on the characteristic of the sensing service and the occupancy state of the second candidate sensing resource is obtained. When the occupancy state of the second candidate sensing resource is unoccupied, the second candidate sensing resource is determined as the second sensing resource. When the occupancy state of the second candidate sensing resource is occupied, the following operations are repeatedly performed until the occupancy state of an updated second candidate sensing resource is unoccupied: determining an updated second candidate sensing resource based on the characteristic of the sensing service, obtaining an occupancy state of the updated second candidate sensing resource, determining the updated second candidate sensing resource as the second sensing resource, and sending the sensing signal based on the second sensing resource.

In the forgoing embodiments, before sending the sensing signal, the UE monitors whether the sensing resource to be used for sending sensing signal is occupied by other devices, and only sends the sensing signal when the sensing resource is not occupied. In addition, in order to avoid resource collision, it is monitored whether the sensing resource is occupied during the process of sending the sensing signal, and if it is occupied, the sensing signal is resent, so as to further ensure the successful sending of the sensing signal.

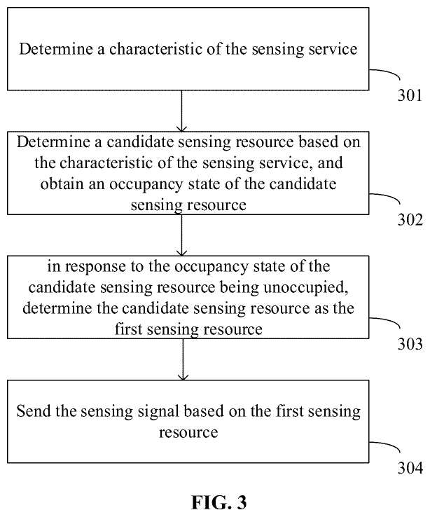

Some embodiments of this disclosure provide a method for sending a sensing signal, which is executed by UE. The method may be executed independently, or may be executed in combination with any of other embodiments of this disclosure. FIG. 3 is a flow chart of a method for sending a sensing signal according to some embodiments. As shown in FIG. 3, the method includes the following content.

In step 301, a characteristic of the sensing service is determined.

In step 302, a candidate sensing resource is determined based on the characteristic of the sensing service, and an occupancy state of the candidate sensing resource is obtained.

In step 303, in response to the occupancy state of the candidate sensing resource being unoccupied, the candidate sensing resource is determined as the first sensing resource.

In step 304, the sensing signal is sent based on the first sensing resource.

In some embodiments, the UE determines the characteristic of the sensing service, determines, based on the characteristic of the sensing service, the candidate sensing resource, and obtains the occupancy state of the candidate sensing resource. When the occupancy state of the candidate sensing resource is unoccupied, the UE determines the candidate sensing resource as the first sensing resource, and sends the sensing signal based on the first sensing resource.

In some embodiments, the UE determines the characteristic of the sensing service, and determines, based on the characteristic of the sensing service, the candidate sensing resource as including: T3 time periods in 30 consecutive time cycles. The UE monitors the T3 time period and obtains the occupancy state thereof. When it is detected that the T3 time period is not occupied, the T3 time periods in the 30 consecutive time cycles are determined as the first sensing resource, and the sensing signal is sent based on the first sensing resource.

In some embodiments, the UE determines the characteristic of the sensing service, and determines, based on the characteristic of the sensing service, the candidate sensing resource as including: T5-T7 time periods in 20 consecutive time cycles. The UE monitors the T5-T7 time periods and obtains the occupancy state thereof. When it is detected that the T5-T7 time periods are not occupied, the T5-T7 time periods in the 20 consecutive time cycles are determined as the first sensing resource, and the sensing signal is sent based on the first sensing resource.

In the forgoing embodiments, before sending the sensing signal, the UE monitors whether the sensing resource to be used for sending sensing signal is occupied by other devices, and only sends the sensing signal when the sensing resource is not occupied, so that the sensing signal can be successfully sent.

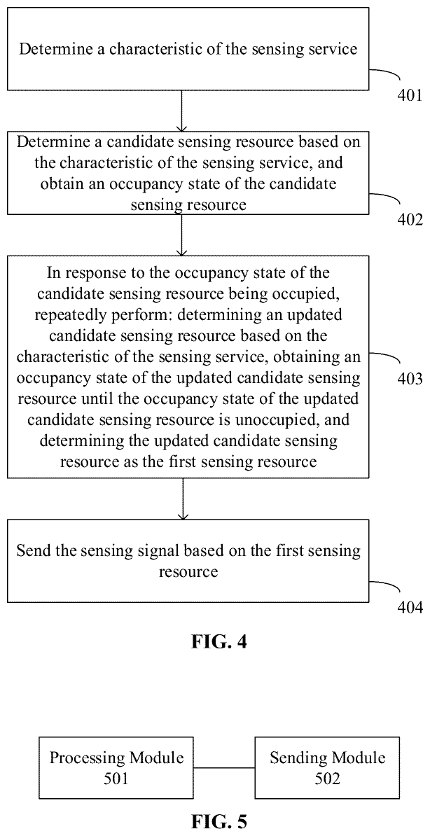

Some embodiments of this disclosure provide a method for sending a sensing signal, which is executed by UE. The method may be executed independently, or may be executed in combination with any of other embodiments of this disclosure. FIG. 4 is a flow chart of a method for sending a sensing signal according to some embodiments. As shown in FIG. 4, the method includes the following content.

In step 401, a characteristic of the sensing service is determined.

In step 402, a candidate sensing resource is determined based on the characteristic of the sensing service, and an occupancy state of the candidate sensing resource is obtained.

In step 403, in response to the occupancy state of the candidate sensing resource being occupied, the following operations are repeatedly performed: determining an updated candidate sensing resource based on the characteristic of the sensing service, obtaining an occupancy state of the updated candidate sensing resource until the occupancy state of the updated candidate sensing resource is unoccupied, and determining the updated candidate sensing resource as the first sensing resource.

In step 404, the sensing signal is sent based on the first sensing resource.

In some embodiments, the UE determines the characteristic of the sensing service, determines, based on the characteristic of the sensing service, the candidate sensing resource, and obtains the occupancy state of the candidate sensing resource. When the occupancy state of the candidate sensing resource is occupied, the following operations are repeatedly performed until the occupancy state of an updated candidate sensing resource is unoccupied:
determining an updated candidate sensing resource based on the characteristic of the sensing service;
obtaining an occupancy state of the updated candidate sensing resource; and
after obtaining an updated candidate sensing resource whose occupancy state is unoccupied, the candidate sensing resource is determined as the first sensing resource, and the sensing signal is sent based on the first sensing resource.

In some embodiments, the UE determines the characteristic of the sensing service, and determines, based on the characteristic of the sensing service, the candidate sensing resource as including: T3 time periods in 30 consecutive time cycles. The UE monitors the T3 time period and obtains the occupancy state thereof. When it is detected that the T3 time period is already occupied, the updated candidate sensing resource is determined based on the characteristic of the sensing service as including: T1 time periods in 30 consecutive time cycles. The UE monitors the T1 time period and obtains the occupancy state thereof. When it is detected that the T1 time period is not occupied, the T1 time periods in the 30 consecutive time cycles are determined as the first sensing resource, and the sensing signal is sent based on the first sensing resource.

In some embodiments, the UE determines the characteristic of the sensing service, and determines, based on the characteristic of the sensing service, the candidate sensing resource as including: T5-T7 time periods in 20 consecutive time cycles. The UE monitors the T5-T7 time periods and obtains the occupancy state thereof. When it is detected that the T5-T7 time periods are already occupied, the updated candidate sensing resource is determined based on the characteristic of the sensing service as including: T1-T3 time periods in 20 consecutive time cycles. The UE monitors the T1-T3 time periods and obtains the occupancy state thereof. When it is detected that the T1-T3 time periods are not occupied, the T1-T3 time periods in the 20 consecutive time cycles are determined as the first sensing resource, and the sensing signal is sent based on the first sensing resource.

In the forgoing embodiments, before sending the sensing signal, the UE monitors whether the sensing resource to be used for sending sensing signal is occupied by other devices, and only sends the sensing signal when the sensing resource is not occupied, so that the sensing signal can be successfully sent.

Some embodiments of this disclosure provide a method for sending a sensing signal, which is executed by UE. The method may be executed independently, or may be executed in combination with any of other embodiments of this disclosure. The method includes:
determining a characteristic of a sensing service;
determining, based on the characteristic of the sensing service, an unoccupied first sensing resource in sensing resources to be allocated; and
sending the sensing signal based on the first sensing resource,
where the sensing resources to be allocated include multiple time cycles in the time domain, and each time cycle includes multiple time periods.

In some embodiments, the UE determines the characteristic of the sensing service, determines, based on the characteristic of the sensing service, the unoccupied first sensing resource among the sensing resources to be allocated, and sends the sensing signal based on the first sensing resource. Herein, the sensing resources to be allocated may be divided into the following time periods in the time domain:
T₀, T₁, T₂, . . . , T_{N-1}, T₀, T₁, T₂, . . . , T_{N-1}, T₀, T₁, T₂, . . . , T_{N-1}, . . . ;
wherein, T₀, T₁, T₂, . . . , T_{N-1} constitute a time cycle, that is, the number of time periods included in a time cycle is N.

In some embodiments, within one time cycle, the durations of the time periods T₀, T₁, T₂, . . . , T_{N-1} may be the same or different.

In the forgoing embodiments, before sending the sensing signal, the UE monitors whether the sensing resource to be used for sending sensing signal is occupied by other devices, and only sends the sensing signal when the sensing resource is not occupied, so that the sensing signal can be successfully sent.

Some embodiments of this disclosure provide a method for sending a sensing signal, which is executed by UE. The method may be executed independently, or may be executed in combination with any of other embodiments of this disclosure. The method includes:
determining a characteristic of a sensing service;
determining, based on the characteristic of the sensing service, an unoccupied first sensing resource in sensing resources to be allocated; and
sending the sensing signal based on the first sensing resource,
where the sensing resources to be allocated include multiple time cycles in the time domain, and each time cycle includes multiple time periods.

For example, the first sensing resource includes L time periods evenly distributed over M time cycles, where each time cycle includes N time periods, distribution positions of the N time periods in respective time cycles are the same, and, among the M time cycles, numbers of time periods between an S-th time cycle and an (S+1)-th time cycle are the same, where L, M, N and S are positive integers greater than or equal to 1, and L=M×N, S≤M−1.

In some embodiments, the UE determines the characteristic of the sensing service, determines, based on the characteristic of the sensing service, the unoccupied first sensing resource among the sensing resources to be allocated, and sends the sensing signal based on the first sensing resource. Herein, the sensing resources to be allocated may include multiple time cycles in the time domain, and each time cycle includes multiple time periods. In addition, the first sensing resource includes time periods distributed over multiple time cycles, where the number of time periods in each time cycle is the same, and the distribution positions are also the same.

In some embodiments, the UE determines the characteristic of the sensing service; determines, based on the characteristic of the sensing service, the unoccupied first sensing resource among the sensing resources to be allocated, where the first sensing resource includes T3 time periods in 30 consecutive time cycles; and sends the sensing signal based on the first sensing resource.

In some embodiments, the UE determines the characteristic of the sensing service; determines, based on the characteristic of the sensing service, the unoccupied first sensing resource among the sensing resources to be allocated, where the first sensing resource includes T5-T7 time periods in 20 time cycles, with any two adjacent time cycles in the 20 time cycles being separated by one time cycle (e.g., the T5-T7 time periods in the 1^{st}, 3^{rd}, . . . , 40^{th} time cycles from the current moment); and sends the sensing signal based on the first sensing resource.

In the forgoing embodiments, before sending the sensing signal, the UE monitors whether the sensing resource to be used for sending sensing signal is occupied by other devices, and only sends the sensing signal when the sensing resource is not occupied, so that the sensing signal can be successfully sent.

Some embodiments of this disclosure provide a method for sending a sensing signal, which is executed by UE. The method may be executed independently, or may be executed in combination with any of other embodiments of this disclosure. The method includes:
determining a characteristic of a sensing service;
determining, based on the characteristic of the sensing service, an unoccupied first sensing resource in sensing resources to be allocated;
sending the sensing signal based on the first sensing resource;
obtaining, during sending of the sensing signal, an occupancy state of the first sensing resource;
determining, in response to the occupancy state of the first sensing resource being occupied, an unoccupied second sensing resource in the sensing resources to be allocated based on the characteristic of the sensing service; and
sending the sensing signal based on the second sensing resource,
where the sensing resources to be allocated include multiple time cycles in the time domain, and each time cycle includes multiple time periods.

For example, the second sensing resource includes L time periods evenly distributed over M time cycles, where each time cycle includes N time periods, distribution positions of the N time periods in respective time cycles are the same, and, among the M time cycles, numbers of time periods between an S-th time cycle and an (S+1)-th time cycle are the same, where L, M, N and S are positive integers greater than or equal to 1, and L=M×N, S≤ M−1.

In some embodiments, the UE determines the characteristic of the sensing service, determines, based on the characteristic of the sensing service, the unoccupied first sensing resource among the sensing resources to be allocated, and sends the sensing signal based on the first sensing resource. In the process of sending the sensing signal, the occupancy state of the first sensing resource is obtained, and if the occupancy state of the first sensing resource is occupied, the unoccupied second sensing resource is determined in sensing resources to be allocated based on the characteristic of the sensing service, and the sensing signal is resent based on the second sensing resource. Herein, the sensing resources to be allocated may include multiple time cycles in the time domain, and each time cycle includes multiple time periods. In addition, the second sensing resource includes time periods distributed over multiple time cycles, where the number of time periods in each time cycle is the same, and the distribution positions are also the same.

In some embodiments, the UE determines the characteristic of the sensing service, determines, based on the characteristic of the sensing service, the unoccupied first sensing resource among the sensing resources to be allocated, and sends the sensing signal based on the first sensing resource. In the process of sending the sensing signal, the occupancy state of the first sensing resource is obtained. If the occupancy state of the first sensing resource is occupied, the unoccupied second sensing resource is determined among the sensing resources to be allocated based on the characteristic of the sensing service, where the second sensing resource includes: T₁ time periods in 30 consecutive time cycles. Then the sensing signal is resent based on the second sensing resource.

In some embodiments, the UE determines the characteristic of the sensing service, determines, based on the characteristic of the sensing service, the unoccupied first sensing resource among the sensing resources to be allocated, and sends the sensing signal based on the first sensing resource. In the process of sending the sensing signal, the occupancy state of the first sensing resource is obtained. If the occupancy state of the first sensing resource is occupied, the unoccupied second sensing resource is determined among the sensing resources to be allocated based on the characteristic of the sensing service, where the second sensing resource includes T₁-T₃ time periods in 20 time cycles, with any two adjacent time cycles in the 20 time cycles being separated by one time cycle, for example, the T₁-T₃ time periods in the 1st, 3rd, . . . , 40th time cycles from the current moment. Then the sensing signal is resent based on the second sensing resource.

In the forgoing embodiments, before sending the sensing signal, the UE monitors whether the sensing resource to be used for sending sensing signal is occupied by other devices, and only sends the sensing signal when the sensing resource is not occupied. In addition, in order to avoid resource collision, it is monitored whether the sensing resource is occupied during the process of sending the sensing signal, and if it is occupied, the sensing signal is resent, so as to further ensure the successful sending of the sensing signal.

Some embodiments of this disclosure provide a method for sending a sensing signal, which is executed by UE. The method may be executed independently, or may be executed in combination with any of other embodiments of this disclosure. The method includes:
determining a characteristic of a sensing service;
determining, based on the characteristic of the sensing service, an unoccupied first sensing resource in sensing resources to be allocated;
sending the sensing signal based on the first sensing resource;
obtaining, during sending of the sensing signal, an occupancy state of the first sensing resource;
determining, in response to the occupancy state of the first sensing resource being occupied, an unoccupied second sensing resource in the sensing resources to be allocated based on the characteristic of the sensing service; and sending the sensing signal based on the second sensing resource, where the sensing resources to be allocated include multiple time cycles in the time domain, and each time cycle includes multiple time periods; and the number of time periods included in the first sensing resource is equal to the number of time periods included in the second sensing resource.

In some embodiments, the UE determines the characteristic of the sensing service, determines, based on the characteristic of the sensing service, the unoccupied first sensing resource among the sensing resources to be allocated, and sends the sensing signal based on the first sensing resource. In the process of sending the sensing signal, the occupancy state of the first sensing resource is obtained, and if the occupancy state of the first sensing resource is occupied, the unoccupied second sensing resource is determined in sensing resources to be allocated based on the characteristic of the sensing service, and the sensing signal is resent based on the second sensing resource. Herein, the sensing resources to be allocated may include multiple time cycles in the time domain, and each time cycle includes multiple time periods. In addition, the number of time periods included in the first sensing resource is equal to the number of time periods included in the second sensing resource.

In some embodiments, the UE determines the characteristic of the sensing service, determines, based on the characteristic of the sensing service, the unoccupied first sensing resource among the sensing resources to be allocated as including: T3 time periods in 30 consecutive time cycles, and sends the sensing signal based on the first sensing resource. In the process of sending the sensing signal, the occupancy state of the first sensing resource is obtained. If the occupancy state of the first sensing resource is occupied, the unoccupied second sensing resource is determined among the sensing resources to be allocated based on the characteristic of the sensing service as including: T1 time periods in 30 consecutive time cycles. Then the sensing signal is resent based on the second sensing resource.

In some embodiments, the UE determines the characteristic of the sensing service, determines, based on the characteristic of the sensing service, the unoccupied first sensing resource among the sensing resources to be allocated as including: T5-T7 time periods in 20 consecutive time cycles, and sends the sensing signal based on the first sensing resource. In the process of sending the sensing signal, the occupancy state of the first sensing resource is obtained. If the occupancy state of the first sensing resource is occupied, the unoccupied second sensing resource is determined among the sensing resources to be allocated based on the characteristic of the sensing service as including: T1-t3 time periods in 20 consecutive time cycles. Then the sensing signal is resent based on the second sensing resource.

In the forgoing embodiments, before sending the sensing signal, the UE monitors whether the sensing resource to be used for sending sensing signal is occupied by other devices, and only sends the sensing signal when the sensing resource is not occupied. In addition, in order to avoid resource collision, it is monitored whether the sensing resource is occupied during the process of sending the sensing signal, and if it is occupied, the sensing signal is resent, so as to further ensure the successful sending of the sensing signal.

Some embodiments of this disclosure provide a method for sending a sensing signal, which is executed by UE. The method may be executed independently, or may be executed in combination with any of other embodiments of this disclosure. The method includes:
determining a characteristic of a sensing service;
determining, based on the characteristic of the sensing service, an unoccupied first sensing resource in sensing resources to be allocated; and
sending the sensing signal based on the first sensing resource;
where the characteristic of the sensing service includes at least one of the following: sensing distance, sensing range, size of a sensed object, shape of the sensed object, motion state of the sensed object.

In some embodiments, the UE determines the characteristic of the sensing service, where the characteristic of the sensing service includes at least one of the following: sensing distance, sensing range, size of a sensed object, shape of the sensed object, motion state of the sensed object; determines, based on the characteristic of the sensing service, the unoccupied first sensing resource among the sensing resources to be allocated; and sends the sensing signal based on the first sensing resource. For example, the characteristic of the sensing service lies in sensing the movement speed of an object(s) of about 1 square meter within a range of 3 to 5 meters. For another example, the characteristic of the sensing service lies in sensing the shape of an object(s) of about 5 square meters within a range of 20 to 30 meters.

In some embodiments, the UE determines the characteristic of the sensing service, where the characteristic of the sensing service includes at least one of the following: sensing distance, sensing range, size of a sensed object, shape of the sensed object, motion state of the sensed object; determines, based on the characteristic of the sensing service, the unoccupied first sensing resource among the sensing resources to be allocated as including: T3 time periods in 30 consecutive time cycles; and sends the sensing signal based on the first sensing resource.

In some embodiments, the UE determines the characteristic of the sensing service, where the characteristic of the sensing service includes at least one of the following: sensing distance, sensing range, size of a sensed object, shape of the sensed object, motion state of the sensed object; determines, based on the characteristic of the sensing service, the unoccupied first sensing resource among the sensing resources to be allocated as including T5-T7 time periods in 20 consecutive time cycles; and sends the sensing signal based on the first sensing resource.

In the forgoing embodiments, before sending the sensing signal, the UE monitors whether the sensing resource to be used for sending sensing signal is occupied by other devices, and only sends the sensing signal when the sensing resource is not occupied, so that the sensing signal can be successfully sent.

Some embodiments of this disclosure provide an apparatus for sending a sensing signal, which is applied to UE and, as shown in FIG. 5, includes:
a processing module 501, configured to determine a characteristic of a sensing service; and determine, based on the characteristic of the sensing service, an unoccupied first sensing resource in sensing resources to be allocated; and
a sending module 502, configured to send the sensing signal based on the first sensing resource.

Some embodiments of this disclosure provide a mobile terminal, including:
a processor; and
a memory, configured to store an instruction executable by the processor;
where the processor is configured to execute the executable instruction in the memory, thereby implementing steps of the forgoing methods for sending the sensing signal.

Some embodiments of this disclosure provide a non-transitory computer-readable storage medium storing an executable instruction thereon, where the executable instruction is used for, when being executed by a processor, implementing steps of the forgoing methods for sending the sensing signal.

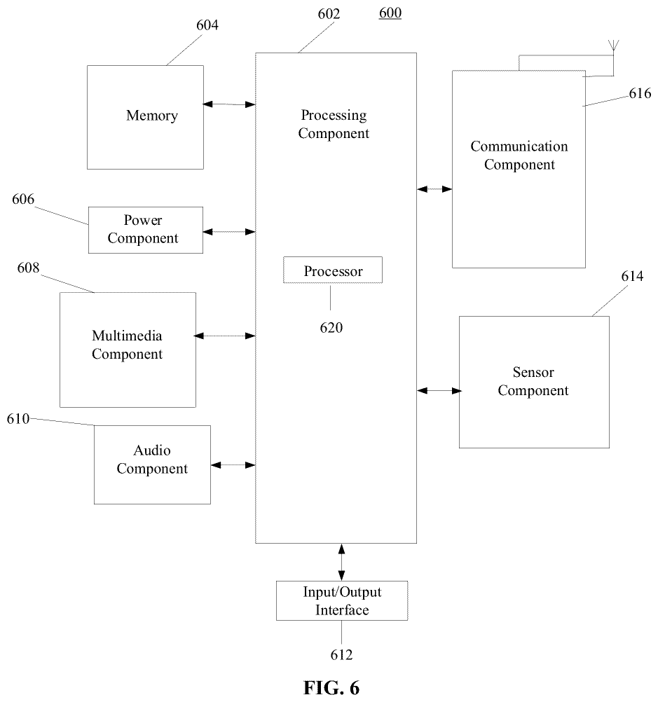

FIG. 6 is a block diagram showing a device 600 for sending a sensing signal according to some embodiments. For example, the device 600 may be a mobile phone, a computer, a digital broadcast terminal, a messaging device, a game console, a tablet device, a medical device, a fitness device, a personal digital assistant, and the like.

Referring to FIG. 6, the device 600 may include one or more of the following components: processing component 602, memory 604, power component 606, multimedia component 608, audio component 610, input/output (I/O) interface 612, sensor component 614, and communication component 616.

The processing component 602 generally controls the overall operation of the device 600, such as operations associated with display, phone calls, data communications, camera operations, and recording operations. The processing component 602 may include one or more processors 620 to execute instructions to perform all or some of the steps of the methods described above. Additionally, the processing component 602 may include one or more modules that facilitate interaction between the processing component 602 and other components. For example, the processing component 602 may include a multimedia module to facilitate interaction between the multimedia component 608 and the processing component 602.

The memory 604 is configured to store various types of data to support operation at the device 600. Examples of such data include instructions, contact data, phonebook data, messages, pictures, videos, and the like for any application or method operating on the device 600. The memory 604 may be implemented by any type of volatile or non-volatile storage device or combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic or optical disk.

The power component 606 provides power to various components of the device 600. The power components 606 may include a power management system, one or more power sources, and other components associated with generating, managing, and distributing power to the device 600.

The multimedia component 608 includes a screen that provides an output interface between the device 600 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel. The touch sensor may not only sense the boundaries of a touch or swipe action, but also detect the duration and pressure associated with the touch or swipe action. In some embodiments, the multimedia component 608 includes a front camera and/or a rear camera. When the device 600 is in an operation mode, such as a shooting mode or a video mode, the front camera and/or the rear camera may receive external multimedia data. Each of the front and rear cameras may be a fixed optical lens system or have focal length and optical zoom capability.

The audio component 610 is configured to output and/or input audio signals. For example, the audio component 610 includes a microphone (MIC) that is configured to receive external audio signals when the device 600 is in operating modes, such as calling mode, recording mode, and voice recognition mode. The received audio signal may be further stored in the memory 604 or transmitted via the communication component 616. In some embodiments, the audio component 610 also includes a speaker for outputting audio signals.

The I/O interface 612 provides an interface between the processing component 602 and a peripheral interface module, which may be a keyboard, a click wheel, a button, or the like. These buttons may include, but are not limited to: home button, volume buttons, start button, and lock button.

The sensor assembly 614 includes one or more sensors for providing state assessments of various aspects of the device 600. For example, the sensor assembly 614 can detect the open/closed state of the device 600, the relative positioning of components, such as the display and keypad of the device 600. The sensor assembly 614 can also detect a change in the position of the device 600 or a component of the device 600, the presence or absence of user contact with the device 600, the orientation or acceleration/deceleration of the device 600, and the temperature change of the device 600. The sensor assembly 614 may include a proximity sensor configured to detect the presence of nearby objects in the absence of any physical contact. The sensor assembly 614 may also include a light sensor, such as a CMOS or CCD image sensor, for use in imaging applications. In some embodiments, the sensor assembly 614 may also include an acceleration sensor, a gyroscope sensor, a magnetic sensor, a pressure sensor, or a temperature sensor.

The communication component 616 is configured to facilitate wired or wireless communication between the device 600 and other devices. The device 600 may access wireless networks based on communication standards, such as WiFi, 2G or 3G, or a combination thereof. In some embodiments, the communication component 616 receives broadcast signals or broadcast related information from an external broadcast management system via a broadcast channel. In some embodiments, the communication component 616 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In some embodiments, the device 600 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic component, which are configured to perform the forgoing methods.

In some embodiments, there is also provided a non-transitory computer-readable storage medium including instructions, such as the memory 604 including instructions, executable by the processor 620 of the device 600 to perform the method described above. For example, the non-transitory computer-readable storage medium may be ROM, random access memory (RAM), CD-ROM, magnetic tape, floppy disk, optical data storage device, and the like.

This application is intended to cover any modification, use or adaptation of this disclosure, and these modifications, uses or adaptations follow the general principles of this disclosure and include common knowledge or conventional technical means in the art, which are not disclosed in this disclosure. The specification and examples are to be considered exemplary only, with a true scope and spirit of the disclosure being indicated by the following claims.

This disclosure is not limited to the precise constructions which have been described above and shown in the drawings, and various modifications and changes may be made without departing from the scope thereof. The scope of this disclosure is limited only by the scope of the appended claims.

### INDUSTRIAL APPLICABILITY

In some embodiments of the present disclosure, before sending the sensing signal, the UE monitors whether the sensing resource to be used for sending sensing signal is occupied by other devices, and only sends the sensing signal when the sensing resource is not occupied, so that the sensing signal can be successfully sent.

1. A method for sending a sensing signal, comprising:
determining, by user equipment (UE), a characteristic of a sensing service;
determining, by the UE based on the characteristic of the sensing service, an unoccupied first sensing resource in sensing resources to be allocated; and
sending the sensing signal based on the first sensing resource.

2. The method according to claim 1, wherein the sensing resources to be allocated are resources on an unlicensed frequency band.

3. The method according to claim 1, further comprising:
obtaining, by the UE, during the sending of the sensing signal, an occupancy state of the first sensing resource; and
in response to the first sensing resource being occupied, determining, by the UE based on the characteristic of the sensing service, an unoccupied second sensing resource in the sensing resources to be allocated; and
sending by the UE, the sensing signal based on the second sensing resource.

4. The method according to claim 1, wherein determining, by the UE based on the characteristic of the sensing service, the unoccupied first sensing resource in the sensing resources to be allocated comprises:
determining, based on the characteristic of the sensing service, a candidate sensing resource, and obtaining an occupancy state of the candidate sensing resource; and
determining, in response to the candidate sensing resource being unoccupied, the candidate sensing resource as the first sensing resource.

5. The method according to claim 1, wherein determining, by the UE based on the characteristic of the sensing service, the unoccupied first sensing resource in the sensing resources to be allocated comprises:
determining, based on the characteristic of the sensing service, a candidate sensing resource, and obtaining an occupancy state of the candidate sensing resource; and
in response to the candidate sensing resource being occupied, determining an updated candidate sensing resource based on the characteristic of the sensing service, obtaining an occupancy state of the updated candidate sensing resource until the updated candidate sensing resource is unoccupied, and determining the updated candidate sensing resource as the first sensing resource.

6. The method according to claim 1, wherein the sensing resources to be allocated comprise multiple time cycles in a time domain, and each time cycle comprises multiple time periods.

7. The method according to claim 6, wherein the first sensing resource comprises:
L time periods evenly distributed over M time cycles, wherein each time cycle comprises N time periods, distribution positions of the N time periods in respective time cycles are the same, and, among the M time cycles, numbers of time periods between an S-th time cycle and an (S+1)-th time cycle are the same, where L, M, N and S are positive integers greater than or equal to 1, and L=M×N, S≤M−1.

8. The method according to claim 3, wherein the second sensing resource comprises:
L time periods evenly distributed over M time cycles, wherein each time cycle comprises N time periods, distribution positions of the N time periods in respective time cycles are the same, and, among the M time cycles, numbers of time periods between an S-th time cycle and an (S+1)-th time cycle are the same, where L, M, N and S are positive integers greater than or equal to 1, and L=M×N, S≤M−1;
the sensing resources to be allocated comprise multiple time cycles in a time domain, and each time cycle comprises multiple time periods.

9. The method according to claim 3, wherein the sensing resources to be allocated comprise multiple time cycles in a time domain, and each time cycle comprises multiple time periods; and
wherein a number of time periods included in the first sensing resource is equal to a number of time periods included in the second sensing resource.

10. The method according to claim 1, wherein the characteristic of the sensing service comprises at least one of following:
sensing distance, sensing range, size of a sensed object, shape of the sensed object, motion state of the sensed object.

11. (canceled)

12. A mobile terminal, comprising:
a processor; and
a memory, configured to store an instruction executable by the processor;
wherein, the processor, upon executing the executable instruction in the memory, is configured to:
determine a characteristic of a sensing service;
determine, based on the characteristic of the sensing service, an unoccupied first sensing resource in sensing resources to be allocated; and
send the sensing signal based on the first sensing resource.

13. A non-transitory computer-readable storage medium storing an executable instruction thereon, wherein the executable instruction is used for, when being executed by a processor, implementing a method for sending the sensing signal, wherein the method comprises:
determining a characteristic of a sensing service;
determining, based on the characteristic of the sensing service, an unoccupied first sensing resource in sensing resources to be allocated; and
sending the sensing signal based on the first sensing resource.

14. The mobile terminal according to claim 12, wherein the sensing resources to be allocated are resources on an unlicensed frequency band.

15. The mobile terminal according to claim 12, wherein the processor is further configured to:
obtain, during the sending of the sensing signal, an occupancy state of the first sensing resource; and
in response to the first sensing resource being occupied, determine, based on the characteristic of the sensing service, an unoccupied second sensing resource in the sensing resources to be allocated; and
send the sensing signal based on the second sensing resource.

16. The mobile terminal according to claim 12, wherein the processor is specifically configured to:
determine, based on the characteristic of the sensing service, a candidate sensing resource, and obtain an occupancy state of the candidate sensing resource; and
determine, in response to the candidate sensing resource being unoccupied, the candidate sensing resource as the first sensing resource.

17. The mobile terminal according to claim 12, wherein the processor is specifically configured to:
determine, based on the characteristic of the sensing service, a candidate sensing resource, and obtain an occupancy state of the candidate sensing resource; and
in response to the candidate sensing resource being occupied, determine an updated candidate sensing resource based on the characteristic of the sensing service, obtain an occupancy state of the updated candidate sensing resource until the updated candidate sensing resource is unoccupied, and determine the updated candidate sensing resource as the first sensing resource.

18. The mobile terminal according to claim 12, wherein the sensing resources to be allocated comprise multiple time cycles in a time domain, and each time cycle comprises multiple time periods.

19. The mobile terminal according to claim 18, wherein the first sensing resource comprises:
L time periods evenly distributed over M time cycles, wherein each time cycle comprises N time periods, distribution positions of the N time periods in respective time cycles are the same, and, among the M time cycles, numbers of time periods between an S-th time cycle and an (S+1)-th time cycle are the same, where L, M, N and S are positive integers greater than or equal to 1, and L=M×N, S≤M−1.

20. The mobile terminal according to claim 15, wherein the second sensing resource comprises:
L time periods evenly distributed over M time cycles, wherein each time cycle comprises N time periods, distribution positions of the N time periods in respective time cycles are the same, and, among the M time cycles, numbers of time periods between an S-th time cycle and an (S+1)-th time cycle are the same, where L, M, N and S are positive integers greater than or equal to 1, and L=M×N, S≤M−1;
the sensing resources to be allocated comprise multiple time cycles in a time domain, and each time cycle comprises multiple time periods.

21. The mobile terminal according to claim 15, wherein the sensing resources to be allocated comprise multiple time cycles in a time domain, and each time cycle comprises multiple time periods; and
wherein a number of time periods included in the first sensing resource is equal to a number of time periods included in the second sensing resource.
